(19) United States
(12) Patent Application Publication
(10) Pub. No.: US 2021/0365831 A1
(43) Pub. Date: Nov. 25, 2021

(54) IDENTIFYING CLAIM COMPLEXITY BY INTEGRATING SUPERVISED AND UNSUPERVISED LEARNING

(71) Applicant: Clara Analytics, Inc., Santa Clara, CA (US)

(72) Inventors: Ji Li, Santa Clara, CA (US); Xi Chen, San Bruno, CA (US); Jayant Lakshmikanthan, San Jose, CA (US); Pramod Jathavedan Akkarachittor, Fremont, CA (US)

(21) Appl. No.: 16/879,622

(22) Filed: May 20, 2020

(51) Int. Cl. G06N 20/00; G06K 9/62; G06Q 40/08

(52) U.S. Cl. CPC G06N 20/00; G06K 9/6256; G06Q 40/08; G06K 9/6282; G06K 9/6226

(57) ABSTRACT

A system and a method are disclosed for a tool receiving, from a client device, an indication of a claim. The tool inputs data of the claim into a supervised machine learning model and receiving as output from the supervised machine learning model a complexity of the claim. The tool inputs the data of the claim into an unsupervised machine learning model and receiving as output from the unsupervised machine learning model an identification of a cluster of candidate claims to which the claim belongs. The tool combines complexity and the identification of the cluster into a combined result, and identifies a cell in a matrix corresponding to the combined result. The tool provides, for display at the client device, an identification of the cell, the cell to be emphasized to the user within a display of the matrix.

### TECHNICAL FIELD

The disclosure generally relates to the field of machine learning, and more particularly relates to integrating output from supervised and unsupervised machine learning models.

### BACKGROUND

Typically, based on a user's task objectives, either supervised learning machine learning models or unsupervised learning machine learning models may be selected to output a prediction in relation to a task. However, there are scenarios where selecting one of supervised or unsupervised learning, to the exclusion of the other, is insufficient, because the results of the selected model are not accurate. In the world of claims, for example, if unsupervised machine learning is selected, such as clustering, one can determine a group of claims that is similar to a given claim. However, predicting complexity of the given claim based on past complexity of the group of claims will result in inaccurate predictions, because even though the group of claims may have similar attributes to the given claim, the given claim may well have a different complexity from each claim in the group. If a supervised machine learning model is selected, a complexity of the claim may be determined based on historical claim data. While the supervised machine learning model may have better predictive results than an unsupervised machine learning, it does not yield claim clusters in terms of their attributes (features). Without contextualizing that prediction, the prediction cannot be explained with similar historical claims.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment including a claim prediction tool.

FIG. 2 illustrates one embodiment of modules and databases used by the claim prediction tool.

FIG. 3 illustrates one embodiment of an exemplary data flow for transferring enterprise data to generic machine learning models.

FIG. 4 illustrates another embodiment of an exemplary data flow for transferring enterprise data to a generic machine learning model.

FIG. 5 illustrates an embodiment for processing data to train a multi-branch model for processing both structured and unstructured claim data.

FIG. 6 illustrates an exemplary data structure including clustering information determined using an unsupervised model.

FIG. 7 illustrates an exemplary user interface for portraying a complexity prediction to a user.

FIG. 8 is a block diagram illustrating components of an example machine able to read instructions from a machine-readable medium and execute them in a processor (or controller).

FIG. 9 illustrates an embodiment of an exemplary flow chart depicting a process for combining output of supervised and unsupervised machine learning models.

FIG. 10 illustrates an exemplary chart showing segmentation based on different features.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium includes a combining output of supervised and unsupervised machine learning models to portray an accurate prediction of an outcome for a claim. In some embodiments, a multi-branch model that is trained to process both structured and unstructured data is used to output a prediction from a supervised machine learning model, and claim clustering data is output from an unsupervised machine learning model. Those outputs are combined (e.g., using additional factors such as an escalation potential) for the claim, and may be depicted by emphasizing a cell of a matrix shown on a graphical user interface to indicate a predicted outcome.

In an embodiment, a claim prediction tool receives, from a client device, an indication of a claim. The claim prediction tool inputs data of the claim into a supervised machine learning model and receives as output from the supervised machine learning model a complexity of the claim. The claim prediction tool inputs the data of the claim into an unsupervised machine learning model and receives as output from the unsupervised machine learning model an identification of a cluster of candidate claims to which the claim belongs. The claim prediction tool combines the complexity and the identification of the cluster into a combined result, and identifies a cell in a matrix corresponding to the combined result. The claim prediction tool provides, for display at the client device, an identification of the cell, the cell to be emphasized to the user within a display of the matrix.

The advantages of the systems and methods disclosed herein will be apparent upon reviewing the detailed description. An exemplary advantage includes ensuring a proper level of granularity on generating clusters, given that where cluster sizes are too granular, the likelihood a new claim belongs to a cluster is low, and where cluster sizes are too broad, then each cluster will include too many distinct claims.

Moreover, a predictive model is rarely 100% accurate. This is especially true when the given data contains only a few features. It is frequently the case for the claim world. The source claim data may include of multiple complex systems, including claim management system, bill system, medical system etc. More often than not, only a subset of all the data is available to a task. For example, sometimes only a subset of structured data is available, and unstructured data is not available, because those structured data are the easiest to process. Furthermore, for using a machine learning model as an API, the models with less features have advantages over those with more features, because models with less features have easier data preparation and pre-processing. In the case of limited data, predictive power is limited from any machine learning model, meaning the prediction is not accurate enough. This turns out to be crucial to take advantages of both supervised and unsupervised learnings. Each of them provides its own predictive strength, and the combination of them provides more. This is particularly helpful when building light weight APIs.

The combination of the supervised and unsupervised learnings is particularly useful in claim complexity prediction, especially when the claim features are limited, e.g. there are only 15 early features out of all 50 features. The early claim features are available during the first 2 weeks from claim open date. First of all, the supervised learning can yield a complexity prediction that is optimal under the given 15 early features. Secondly, the unsupervised learning (clustering) can yield claim clusters that have similar claim characteristics for explanation, again based on the 15 early features. Thirdly, the claim clusters can be mapped to a large historical database with 50 features, and one can extend the analysis to the 35 late features and examine the possible trajectories of the claims in the future.

### Network Environment for Claim Prediction Tool

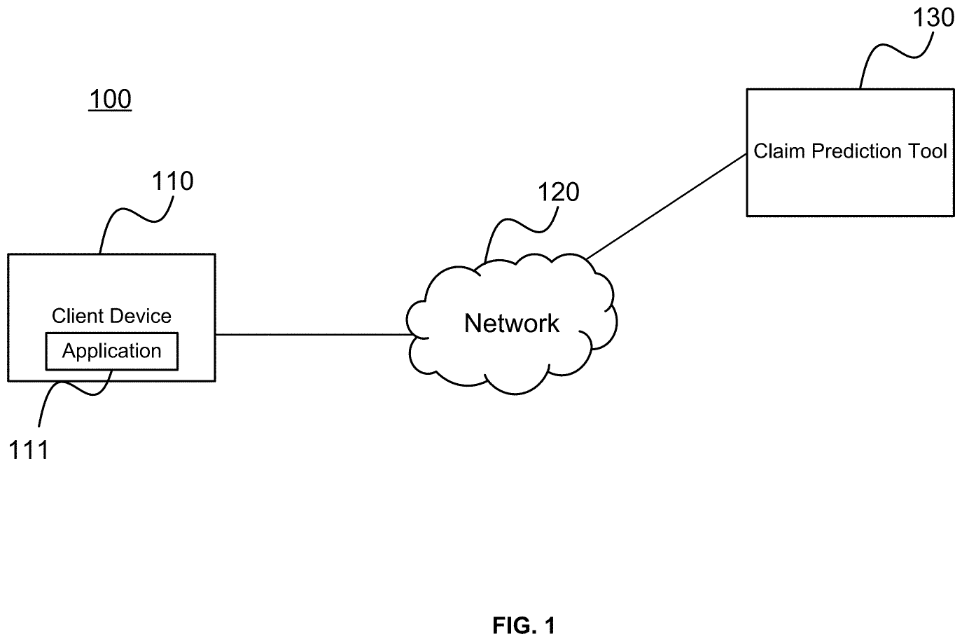

FIG. 1 illustrates one embodiment of a system environment including a claim prediction tool. Environment 100 includes client device 110, with application 111 installed thereon. Client device 110 communications with claim prediction tool 130 over network 120. Here only one client device 110 and claim prediction tool 130 are illustrated, but there may be multiple instances of each of these entities, and the functionality of claim prediction tool 130 may be distributed, or replicated, across multiple servers.

Client device 110 is used by an end user, such as an agent of an insurance company, to access claim prediction tool 130. Client device 110 may be a computing device such as smartphones with an operating system such as ANDROID® or APPLE® IOS®, tablet computers, laptop computers, desktop computers, electronic stereos in automobiles or other vehicles, or any other type of network-enabled device on which digital content may be listened to or otherwise experienced. Typical client devices include the hardware and software needed to input and output sound (e.g., speakers and microphone) and images, connect to the network 110 (e.g., via Wifi and/or 4G or other wireless telecommunication standards), determine the current geographic location of the client devices 100 (e.g., a Global Positioning System (GPS) unit), and/or detect motion of the client devices 100 (e.g., via motion sensors such as accelerometers and gyroscopes).

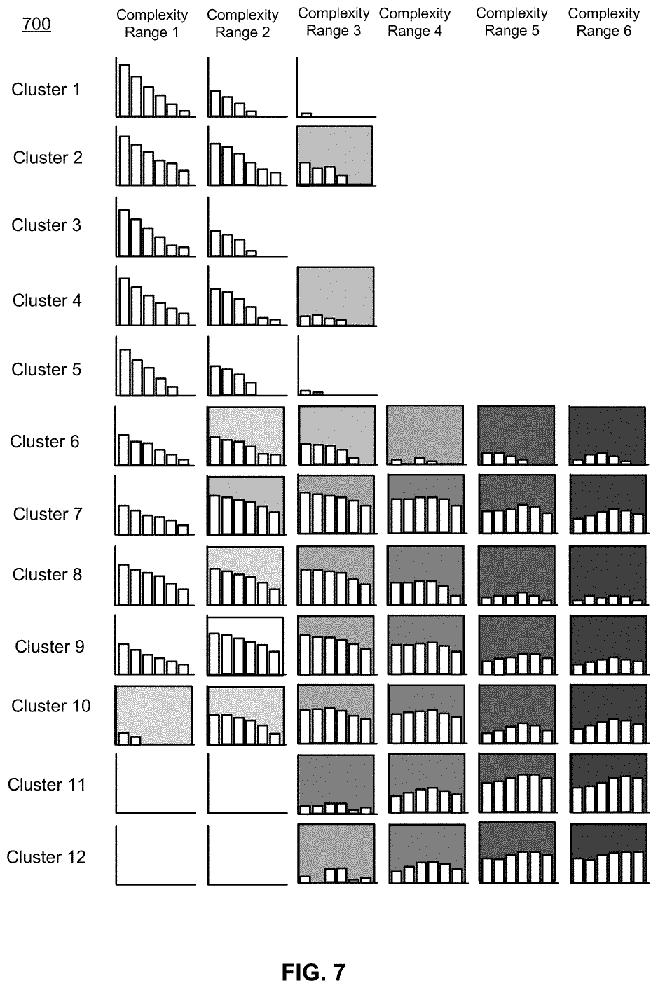

Application 111 may be used by the end user to access information from claim prediction tool 130. For example, claim predictions and other information provided by claim prediction tool 130 may be accessed by the end user through application 111, such as the interfaces discussed with respect to FIG. 7 herein. Application 111 may be a dedicated application installed on client device 110, or a service provided by claim prediction tool that is accessible by a browser or other means.

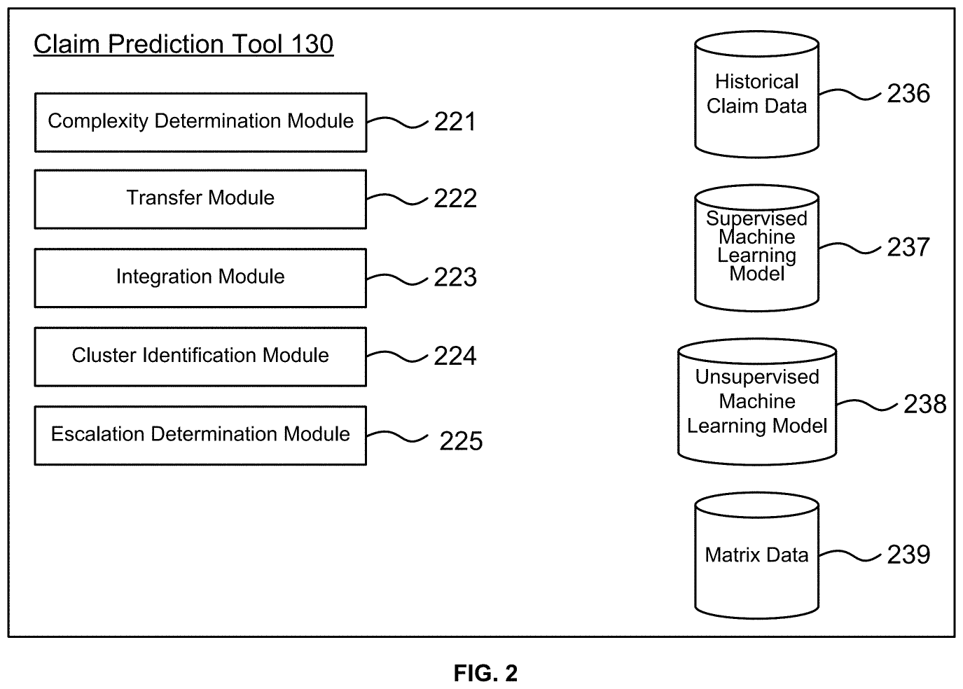

Claim prediction tool 130 outputs a prediction with respect to a claim. In a non-limiting embodiment used throughout this specification for exemplary purposes, claim prediction tool 130 outputs, for a particular indicated claim, a prediction of complexity based on a cluster to which the claim corresponds. The particular mechanics of claim prediction tool 130 are disclosed in further detail below with respect to FIGS. 2-9.

### Claim Prediction Tool—Exemplary Modules and Training

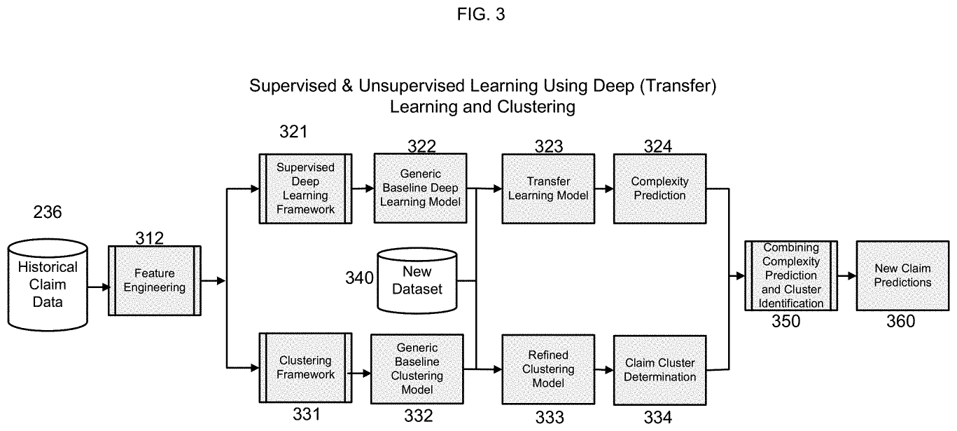

FIG. 2 illustrates one embodiment of modules and databases used by the claim prediction tool. Claim prediction tool 130, as depicted, includes complexity determination module 221, transfer module 222, claim data processing module 223, cluster identification module 224, escalation determination module 225, and training module 226. Claim prediction tool 130, as depicted, also includes various databases, such as historical claim data 236, supervised machine learning model 237, unsupervised machine learning model 238, and matrix data 239. The modules and databases depicted in FIG. 3 are merely exemplary; more or fewer modules and/or databases may be used by claim prediction tool 130 in order to achieve the functionality described herein. Moreover, these modules and/or databases may be located in a single server, or may be distributed across multiple servers. Some functionality of claim prediction tool 130 may be installed directly on client device 110 as a component of application 111.

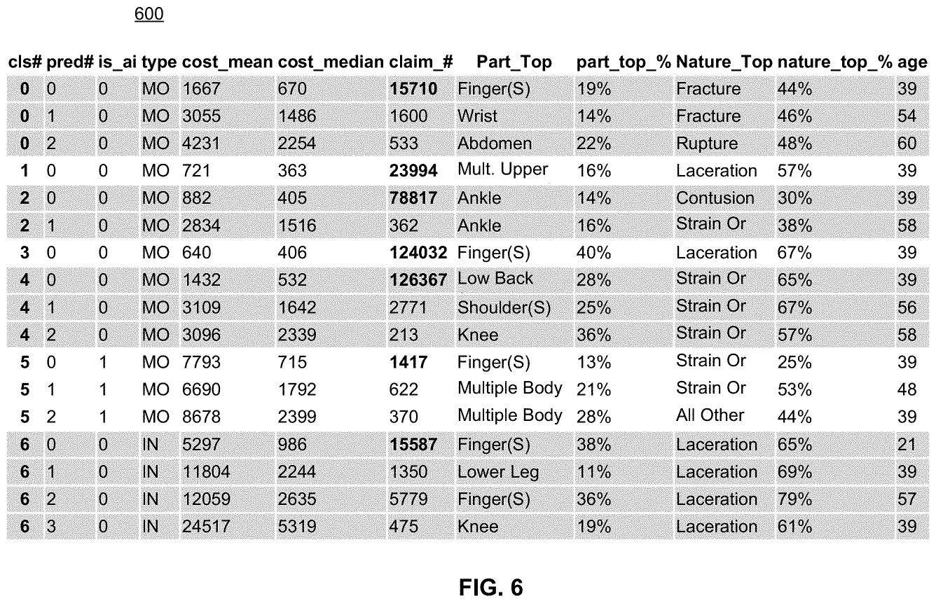

Claim prediction tool 130 outputs a prediction for a given claim based on output from both a supervised and an unsupervised machine learning model. Complexity determination module 221 determines the complexity of a given claim, and in parallel, cluster identification module 224 (discussed in further detail below with reference to FIG. 6) determines a cluster to which the given claim belongs. The term complexity, as used herein, may refer to a value, or range of values, that correspond to an outcome of a claim. For example, in the case of a workers' compensation insurance claim, it may be the case that historically, the majority of claims having similar parameters amounted to a cost that was within a particular range of cost values. In such an example, complexity refers to a range of cost amounts to which the claim is likely to correspond.

Looking for now at the complexity determination, in order to determine the complexity of a given claim, complexity determination module 221 inputs the claim into supervised machine learning model 237, and receives as output from supervised machine learning model 237 the complexity. Supervised machine learning model 237 may be trained using historical data, enterprise-specific data (e.g., an insurance company's own data), or some combination thereof. Training samples includes any data relating to historical claims, such as an identifier of the claim, a category or cluster of claim type to which the claim corresponds, a resulting complexity of the claim (e.g., total cost), claimant information, (e.g., age, injury, how long it took claimant to go back to work, etc.), attorney information (e.g., win/loss rate, claimant or insurance attorney, etc.), and so on. Given the training samples, supervised machine learning model 237 may use deep learning to fit claim information to a resulting complexity, thus enabling a prediction of the resulting complexity for a new claim based on information associated with the new claim.

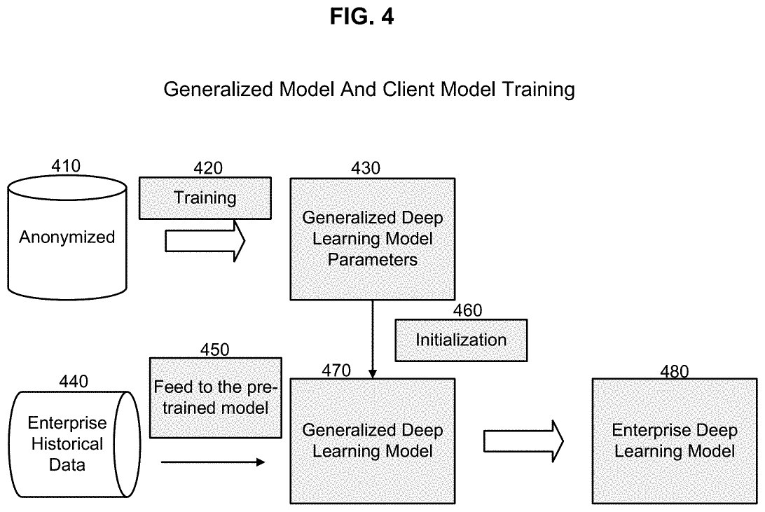

In general, to produce the training samples, historical claim data known to claim prediction tool 130 is anonymized to predict the privacy of claimants (e.g., by striking personal identifying information from the training samples), thus resulting in a generic model for predicting the outcome of future claims. There are some scenarios where enterprises using claim prediction tool 130 may desire a more targeted model that is more specific to the specific types of claims that these enterprises historically process, and thus may wish to supplement the training samples with historical claim data of their own. This supplementing process is referred to herein as a “transfer,” and is described in further detail with respect to FIGS. 3-4.

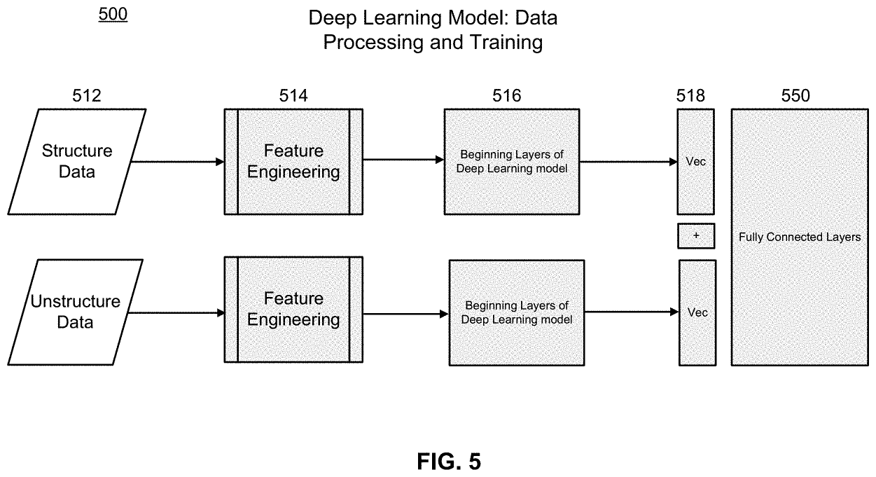

Turning now to FIG. 3, FIG. 3 illustrates one embodiment of an exemplary data flow for transferring enterprise data to generic machine learning models. While FIG. 3 explores parallel input of data into both a supervised and unsupervised machine learning model for a new claim outcome prediction, for now this disclosure will focus on the training and output of the supervised machine learning model. The data flow begins with historical claim data 236 being fed to a feature engineering engine 312. The feature engineering engine 312 is optional, and may manipulate the historical claim data in any manner desired, such as by weighting certain parameters, filtering out certain parameters, normalizing claim data, separating structured and unstructured data (e.g., as described with respect to FIG. 5 below), and so on. Following feature engineering (if performed), complexity determination module 221 inputs the claim data to supervised deep learning framework 321, which results in generic baseline deep learning model 322. Generic baseline deep learning model 322 is, as described above, a supervised machine learning model now trained to predict complexity based on the historical claim data.

Where an enterprise wishes to use a more targeted model by supplementing the training samples with claim data of its own, transfer module 222 may supplement the training of generic baseline deep learning model 322 by transferring data of new dataset 340 (which includes the enterprise data) as training data into generic baseline deep learning model 322. Transfer module 222 may perform this supplementing responsive to receiving a request (e.g., detected using an interface of application 111) to supplement the training data with enterprise data. Transfer module 222 may transmit new dataset 340 to transfer learning model 323, which may take as input generic baseline deep learning model 322, as well as new dataset 340, and modify generic baseline deep learning model 322 (e.g., using the same training techniques described with respect to elements 312, 321, and 322) to arrive at a fully trained supervised machine learning model 237. At this point, training is complete (unless and until transfer module 222 detects a request for further transfer of further new datasets 340). When a new claim is then input by the enterprise for determining complexity, a complexity prediction 324 is output by supervised machine learning model 237. Using transfer module 222 enables new enterprises to achieve accurate results even where they only have a small amount of data, in that the small amount of data can be supplemented by the generic model to be more robust.

FIG. 4 illustrates another embodiment of an exemplary data flow for transferring enterprise data to a generic machine learning model. FIG. 4 begins with anonymized data 410 (e.g., as retrieved from historical claim data 236 and discussed with respect to FIG. 3) being used to train 420 a generalized deep learning model 470 to have certain parameters (generalized deep learning model parameters 430). Initialization 460 is performed on the parameters, resulting in generalized deep learning model 470. Meanwhile, enterprise historical data 440 (e.g., corresponding to new dataset 340 as retrieved from an enterprise database) is fed 450 to generalized deep learning model 470. Following training on the enterprise historical data 440, enterprise deep learning model 480 results, reflecting enterprise-specific training data for fitting new claim data, thus resulting in more accurate complexity predictions.

When training supervised machine learning model 237 to predict complexity for a given claim, both structured and unstructured claim data needs to be parsed. Claims tend to have both of these types of data—for example, pure textual data (e.g., doctor's notes in a medical record file) is unstructured, whereas structured data may include predefined features, such as numerical and/or categorical features describing a claim (e.g., claim relates to “wrist” injury, as selected from a menu of candidate types of injuries). Structured data tends to have low dimensionality, whereas unstructured claims data tends to have high dimensionality. Combining these two types of data is not possible using existing machine learning models, because existing machine learning models cannot reconcile data having different dimensionality, and thus multiple machine learning models would be required to process structured an unstructured claim data separately, resulting in a high amount of required processing power. Integration module 223 integrates training for both structured and unstructured claims data into a single supervised machine learning model 237 that is trained to output complexity based on both types of claim data.

FIG. 5 illustrates an embodiment for processing data to train a multi-branch model for processing both structured and unstructured claim data. Multi-branch model 500 is trained for processing data types 512—that is, both structured data, and unstructured data. For each data type, feature engineering 514 (similar to that described with respect to FIG. 3) is performed on training data, resulting in separate branches of multi-branch model 500 that are trained to process structured data, and unstructured data, separately. Each layer includes respective parameter vectors 518, which show parameters (e.g., in latent space) based on training data of their respective claim types. Integration module 223 back-propagates the representations to fully connected layers 550, which are thereby trained using both structured and unstructured data from their respective branches, thus resulting in supervised machine learning model 237 (perhaps in conjunction with transfer learning for claims imported by an enterprise, as discussed with respect to FIGS. 3-4). When new claim data is input into multi-branch model 500, integration module 223 runs the new claim data through fully connected layers 550, which outputs a prediction of the complexity for that new claim.

Turning back to FIG. 2, when processing new claim data, claim prediction tool 130 determines a cluster to which a claim belongs in parallel with determining complexity of a claim. The term cluster, as used herein, may refer to a grouping of historical claims to which a new claim most closely corresponds. In order to determine to which cluster a new claim corresponds, cluster identification module 224 inputs the claim data into unsupervised machine learning model 238, and receives an identification of a cluster to which the new claim corresponds.

Unsupervised machine learning model 238 is trained by performing a clustering algorithm on historical claim data 236. FIG. 6 illustrates an exemplary data structure including clustering information determined using an unsupervised model. Table 600 includes a cluster identification in the left-most column, and parameters of different claims in the remaining columns, such as the age of a claimant, a nature of the claimant's injury, a body part injured, and so on. The clustering algorithm groups the historical claim data shown in table 600 so that similar claims are grouped together under a cluster identifier. The definition of what factors into a similar claim determination may be assigned by an administrator; that is, an administrator may weight certain claim parameters, such as a claimant's age, an injured body part, a type of injury, cost, whether a claim is indemnified, etc., more highly or less highly than other parameters. As new claims are input into unsupervised machine learning model 238, those claims are assigned to a closest cluster (e.g., of table 600), and that closest cluster's cluster ID is output by unsupervised machine learning model 238.

Returning to FIG. 3, FIG. 3 shows the parallel determination of a complexity prediction and a claim cluster determination. Feature engineered historical claim data (discussed above where FIG. 3 was first introduced) is fed into a clustering algorithm (that is, clustering framework 331), which results in a generic baseline clustering model 332. Optionally, where an enterprise desires a more tailored model, historical claim data from an enterprise (e.g., new dataset 340) is used to refine 333 the clustering model by transfer module 222. Unsupervised machine learning model 238 is now trained. When new claim data is received, it is input into unsupervised machine learning model 238, which outputs 334 a claim cluster determination (e.g., based on use of a nearest neighbor determination algorithm).

Having both a complexity prediction and a claim cluster determination, claim prediction tool 130 combines 350 the complexity prediction and the cluster identification, and outputs 360 a prediction for the new claim. In order to combine the complexity prediction and the cluster identification, a graph is used, where one axis corresponds to complexity, and the other corresponds to clusters; the intersection is representative of the output prediction. An exemplary graph, or matrix, is shown in FIG. 7.

FIG. 7 illustrates an exemplary user interface for portraying a complexity prediction to a user. Matrix 700 shows clusters on a vertical axis, and complexity ranges on a horizontal axis. The clusters are representative of different cluster identifications, as described above with reference to FIG. 6. The complexity ranges correspond to complexities within the lower and upper bounds of those ranges. For example, where complexity is representative of claim cost, complexity range 1 may represent a range of $0-$1,500 in claim cost. If the complexity prediction is $1,250 for a new claim, the new claim would fall within complexity range 1.

The cells at each cluster-complexity range intersection show probability curves for actual complexity values within their corresponding complexity ranges. These probability curves are populated based on historical claim data 236 (and including historical enterprise data, if used), and are static unless historical claim data 236 is updated. The probability data is stored in a database as matrix data 239. The probability curves are represented as histograms, but may be represented using any known statistical representation.

Also shown in matrix 700 is shading in some cells. Shading corresponds to escalation potential. The term escalation potential, as used herein, may correspond to a probability that the predicted complexity range is inaccurate and/or is likely to be higher than predicted. Escalation determination module 225 determines, using the historical claim data, the probability of inaccuracy. For example, escalation determination module 225 examines historical data of similar claims in the cluster and determines how many (e.g., a percentage) of those claims that ended up with a higher cost than supervised machine learning model 237 would have predicted. The higher the percentage, the higher the escalation potential. Escalation determination module 225 may represent the escalation potential within each cell. As depicted, grayscale shading is used, where a darker shading in the background of the cell represents a higher escalation potential; however, any representation may be used (e.g., coloration, scoring, etc.). In an embodiment, claim prediction tool 130 may weight a determined complexity of a new claim based on its escalation potential, thus adjusting the predicted complexity of a new claim.

In order to output the prediction, claim prediction tool 130 accentuates a cell of matrix 700 as the prediction. For example, where the complexity prediction is within complexity range 4, and the new claim's cluster is determined to be cluster six, the intersecting cell may have a box placed around it, may be highlighted using certain coloration, and/or any other means of accentuation. Matrix 700, along with the accentuation of a cell, may be displayed on client device 110 using application 111. A user of client device 111 may be enabled by application 111 to navigate to the data that informed the prediction.

### Computing Machine Architecture

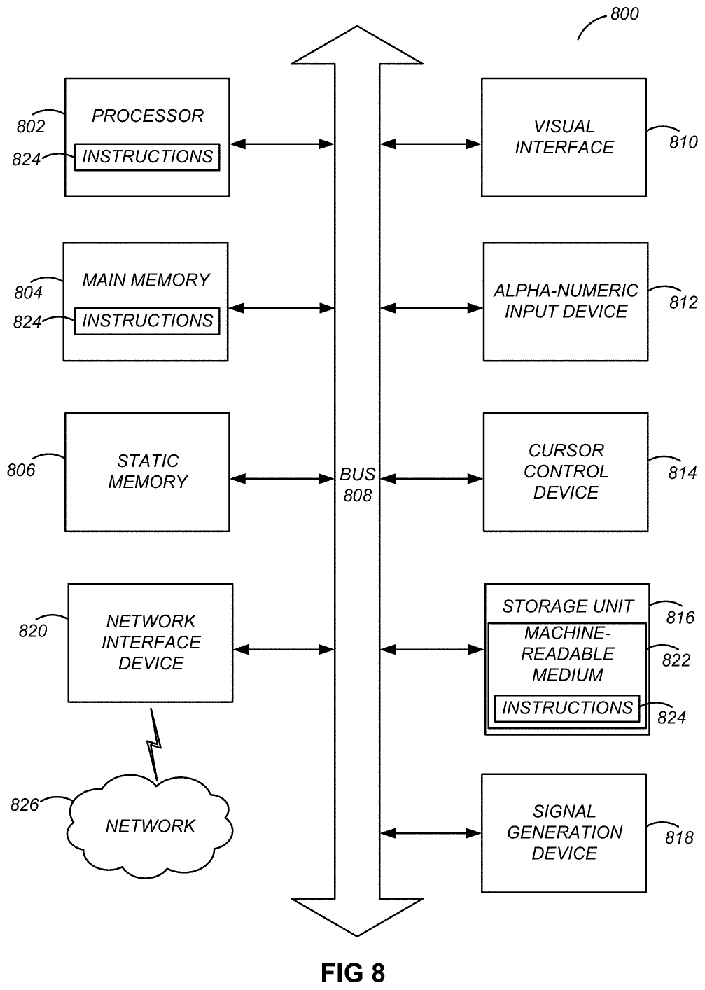

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which program code (e.g., software) for causing the machine to perform any one or more of the methodologies discussed herein may be executed. The program code may be comprised of instructions 824 executable by one or more processors 802. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include visual display interface 810. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 810 may include or may interface with a touch enabled screen. The computer system 800 may also include alphanumeric input device 812 (e.g., a keyboard or touch screen keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Exemplary Data Flow For Claim Prediction

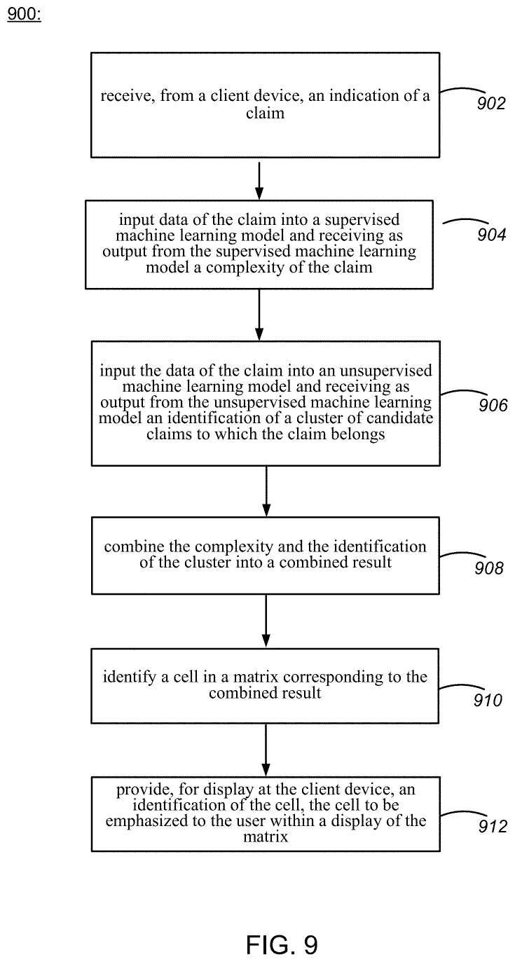

FIG. 9 illustrates an embodiment of an exemplary flow chart depicting a process for combining output of supervised and unsupervised machine learning models. Process 900 begins with claim prediction tool 130 (e.g., using processor 802) receiving 902, from a client device (e.g., client device 110), an indication of a claim. Claim prediction tool 130 inputs 904 data of the claim into a supervised machine learning model (e.g., supervised machine learning model 237) and receiving as output from the supervised machine learning model a complexity of the claim (e.g., a cost value, or a range of possible cost values, corresponding to the claim).

Claim prediction tool 130 inputs 906 (e.g., in parallel to 904, as depicted in FIG. 3) the data of the claim into an unsupervised machine learning model (e.g., unsupervised machine learning model 238, and receives as output from the unsupervised machine learning model an identification of a cluster of candidate claims to which the claim belongs (e.g., cluster identifiers, as depicted in table 600). Claim prediction tool 130 combines 908 the complexity and the identification of the cluster into a combined result, and identifies 910 a cell in a matrix corresponding to the combined result (e.g., an intersection of a cluster identifier and a complexity range in matrix 700). Claim prediction tool provides for 912 display at the client device an identification of the cell, the cell to be emphasized to the user within a display of the matrix (e.g., an accentuation on matrix 700).

### Additional Configuration Considerations

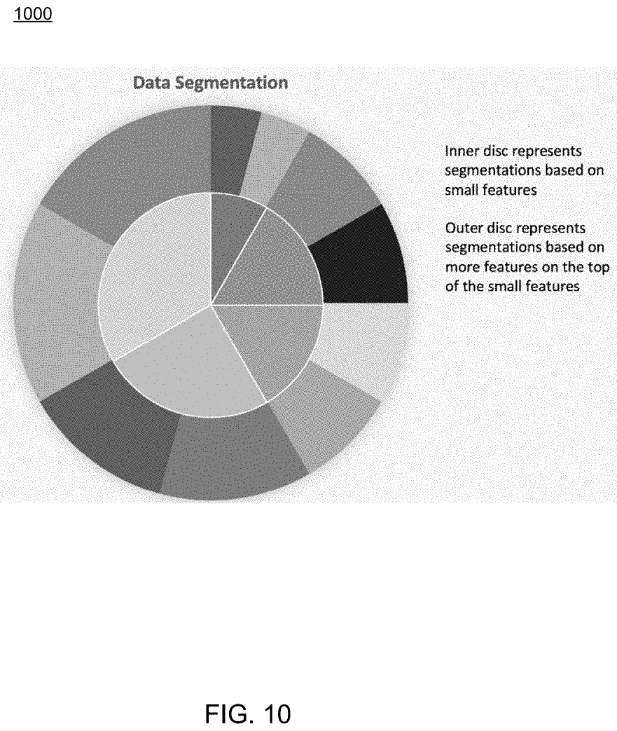

The systems and methods disclosed herein lean on insurance examples for convenience, and may apply to more broadly to other fields. For example, where a dataset needs to be segmented, such as, segmenting financial data by fraud likelihood, or predicting people groups' income levels based on other demographics data. For each of those different purposes, the integrated technique of supervised and unsupervised learnings disclosed herein may be applied to optimize the data segmentation by using supervised learning to achieve optimized predictions, and by using unsupervised learning to add explanations. When using a small data (maybe in the sense of both small data volume and small feature set) to build APIs, this technique can obtain more accurate predictions using historical data with more data than the given small data (that is, through transfer learning). Moreover, by using historical data with more features than the given small feature set, more colors to the predictions and explanations can be added. For example, the new small data has N features, while the historical data has M features (M>N). The small data is segmented per the N features, and the segmentation can be mapped to the bigger data with M features, so one can examine the possibilities of those datapoints using not only the N features, but also the additional M-N features which is not even available to the original small data. Those possibilities may include important information about the predictions and explanations. FIG. 10 illustrates an exemplary chart showing segmentation based on different features. Chart 1000 illustrates a mapping between smaller and bigger feature sets.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for predicting claim outcomes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for combining output of supervised and unsupervised machine learning models, the method comprising:
receiving, from a client device, an indication of a claim;
inputting data of the claim into a supervised machine learning model and receiving as output from the supervised machine learning model a complexity of the claim;
inputting the data of the claim into an unsupervised machine learning model and receiving as output from the unsupervised machine learning model an identification of a cluster of candidate claims to which the claim belongs;
combining the complexity and the identification of the cluster into a combined result;
identifying a cell in a matrix corresponding to the combined result; and
providing, for display at the client device, an identification of the cell, the cell to be emphasized to the user within a display of the matrix.

2. The method of claim 1, wherein the supervised machine learning model was trained using a generic set of training data, wherein the client device corresponds to an enterprise, wherein the enterprise has access to historical claim data, and wherein the training of the supervised machine learning model is supplemented by undergoing a training process using the historical claim data of the enterprise.

3. The method of claim 1, wherein the data of the claim comprises structured and unstructured data, wherein the supervised machine learning model is a multi-branch machine learning model with a first branch trained to process structured data and a second branch trained to process unstructured data.

4. The method of claim 3, wherein the multi-task model comprises shared layers trained to combine the unstructured data and the structured data in order to output the complexity.

5. The method of claim 1, wherein combining the complexity and the identification of the cluster into a combined result comprises:
determining an escalation potential of the claim; and
weighting the complexity based on the determined escalation potential.

6. The method of claim 5, wherein determining the escalation potential comprises:
identifying historical cost predictions of historical claims and actual claim costs for those historical claims;
determining a relative amount of the historical claims having an actual claim cost higher than a historical cost prediction; and
determining the escalation potential based on the relative amount.

7. The method of claim 1, wherein the matrix is generated as having, in a first dimension, a first axis corresponding to an amount of clusters of candidate claims, and in a second dimension, a second axis corresponding to different ranges of complexity values.

8. The method of claim 7, wherein the matrix comprises, at each intersection of the first axis and the second axis, a cell, the cell indicating a relative complexity value with respect to surrounding cells.

9. The method of claim 8, wherein each cell comprises a probability curve indicating a likelihood that a given claim matching that cell will have a given value.

10. A non-transitory computer-readable medium comprising memory with instructions encoded thereon for combining output of supervised and unsupervised machine learning models, the instructions when executed causing one or more processors to perform operations, the instructions comprising instructions to:
receive, from a client device, an indication of a claim;
input data of the claim into a supervised machine learning model and receiving as output from the supervised machine learning model a complexity of the claim;
input the data of the claim into an unsupervised machine learning model and receiving as output from the unsupervised machine learning model an identification of a cluster of candidate claims to which the claim belongs;
combine the complexity and the identification of the cluster into a combined result;
identify a cell in a matrix corresponding to the combined result; and
provide, for display at the client device, an identification of the cell, the cell to be emphasized to the user within a display of the matrix.

11. The non-transitory computer-readable medium of claim 10, wherein the supervised machine learning model was trained using a generic set of training data, wherein the client device corresponds to an enterprise, wherein the enterprise has access to historical claim data, and wherein the training of the supervised machine learning model is supplemented by undergoing a training process using the historical claim data of the enterprise.

12. The non-transitory computer-readable medium of claim 10, wherein the data of the claim comprises structured and unstructured data, wherein the supervised machine learning model is a multi-branch machine learning model with a first branch trained to process structured data and a second branch trained to process unstructured data.

13. The non-transitory computer-readable medium of claim 12, wherein the multi-task model comprises shared layers trained to combine the unstructured data and the structured data in order to output the complexity.

14. The non-transitory computer-readable medium of claim 10, wherein the instructions to combine the complexity and the identification of the cluster into a combined result comprise instructions to:
determine an escalation potential of the claim; and
weight the complexity based on the determined escalation potential.

15. The non-transitory computer-readable medium of claim 14, wherein the instructions to determine the escalation potential comprise instructions to:
identify historical cost predictions of historical claims and actual claim costs for those historical claims;
determine a relative amount of the historical claims having an actual claim cost higher than a historical cost prediction; and
determine the escalation potential based on the relative amount.

16. The non-transitory computer-readable medium of claim 10, wherein the matrix is generated as having, in a first dimension, a first axis corresponding to an amount of clusters of candidate claims, and in a second dimension, a second axis corresponding to different ranges of complexity values.

17. The non-transitory computer-readable medium of claim 16, wherein the matrix comprises, at each intersection of the first axis and the second axis, a cell, the cell indicating a relative complexity value with respect to surrounding cells.

18. The non-transitory computer-readable medium of claim 17, wherein each cell comprises a probability curve indicating a likelihood that a given claim matching that cell will have a given value.

19. A system for combining output of supervised and unsupervised machine learning models, the system comprising:
a communications module for receiving, from a client device, an indication of a claim;
a complexity determination module for inputting data of the claim into a supervised machine learning model and receiving as output from the supervised machine learning model a complexity of the claim;
a cluster identification module for inputting the data of the claim into an unsupervised machine learning model and receiving as output from the unsupervised machine learning model an identification of a cluster of candidate claims to which the claim belongs; and
an integration module for:
combining the complexity and the identification of the cluster into a combined result;
identifying a cell in a matrix corresponding to the combined result; and
providing, for display at the client device, an identification of the cell, the cell to be emphasized to the user within a display of the matrix.

20. The system of claim 19, wherein the system further comprises an escalation determination module for determining an escalation potential of the claim, wherein the integration module is further for weighting the complexity based on the determined escalation potential.
